(19) United States
(12) Patent Application Publication
(10) Pub. No.: US 2019/0095958 A1
(43) Pub. Date: Mar. 28, 2019

(54) INFORMATION PROCESSING APPARATUS AND NON-TRANSITORY COMPUTER READABLE MEDIUM STORING PROGRAM FOR CREATING PROMOTIONAL INFORMATION

(71) Applicant: FUJI XEROX CO., LTD., Tokyo (JP)

(72) Inventor: Chihiro KAWABE, Yokohama-shi (JP)

(73) Assignee: FUJI XEROX CO., LTD., Tokyo (JP)

(21) Appl. No.: 16/117,785

(22) Filed: Aug. 30, 2018

(30) Foreign Application Priority Data
Sep. 27, 2017 (JP) 2017-185828

(51) Int. Cl. G06Q 30/02; G06Q 10/08; G06Q 30/00

(52) U.S. Cl. CPC G06Q 30/0272; G06Q 30/01; G06Q 30/0276; G06Q 10/087

(57) ABSTRACT

An information processing apparatus comprises a processor configured to: (1) set a priority level for each product in a product group by using a first information and a second information of the each product, the first information related to a sales time limit, the second information related to a sales status; and (2) output data for presenting promotional information created based on the priority level.

### CROSS REFERENCE TO RELATED APPLICATION

This application is based on and claims priority under 35 USC 119 from Japanese Patent Application No. 2017-185828 filed Sep. 27, 2017.

### BACKGROUND

### Technical Field

The present disclosure relates to an information processing apparatus and a non-transitory computer readable medium storing a program for creating promotional information.

### SUMMARY

Aspects of non-limiting embodiments of the present disclosure relate to, in selectively promoting products that needs promotion in a product group, presenting promotional information that better reflects constant status changes of products than methods that use pre-fixed information of the products to determine their priority levels.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: set a priority level for each product in a product group by using first information and second information of the each product, the first information related to a sales time limit, the second information related to a sales status; and output data for presenting promotional information created based on the priority level.

### BRIEF DESCRIPTION OF DRAWINGS

Exemplary embodiment(s) of the present invention will be described in detail based on the following figures, wherein:

FIG. 1 is a diagram illustrating the hardware configuration of an information processing apparatus 10;

FIG. 2 is a diagram illustrating a product database;

FIG. 3 is a diagram illustrating a sales history database;

FIG. 4 is a flowchart illustrating a data output procedure;

FIG. 5 is a diagram illustrating promotional information;

FIG. 6 is a flowchart illustrating a data output procedure;

FIG. 7 is a diagram illustrating a product layout; and

FIG. 8 is a diagram illustrating a database of media used to show promotional information.

### DETAILED DESCRIPTION

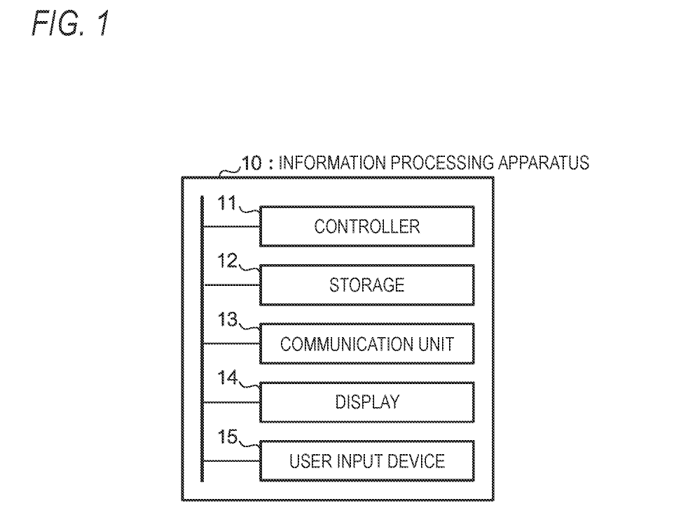

An exemplary embodiment of the present invention will be described below. FIG. 1 is a diagram illustrating the hardware configuration of the information processing apparatus 10. The information processing apparatus 10 includes a controller 11, a storage 12, a communication unit 13, a display 14, and a user input device 15.

The controller 11 includes a processor, such as a central processing unit (CPU), and a memory, such as a read only memory (ROM) and a random access memory (RAM). The ROM stores firmware in which a procedure for starting up the hardware and the operation system (OS) is defined. The RAM is used to store data when the CPU executes an arithmetic operation. The storage 12 includes, for example, a semiconductor memory and a hard disk drive, and stores software such as the OS and application programs. The communication unit 13 includes a communication interface (I/F) for communicating with another electronic device, and is connected to a communication line such as a local area network (LAN).

The display 14 includes a display unit such as a liquid crystal display panel and displays a graphical user interface (GUI) with widgets for operating the information processing apparatus 10. The user input device 15 includes, for example, a keyboard and a pointing device, and accepts an operation on the GUI. Examples of the pointing device include a touch-sensitive panel on the surface of the display 14, a mouse, and a touchpad. The display unit 14 and/or the input unit 15 may be configured separately from the information processing apparatus 10.

The storage 12 stores a program that defines a data output procedure pertaining to the embodiment, the program causing the controller 11 to:

(1) set a priority level for each product in a product group by using first information and second information of the each product; (2) output data for presenting promotional information created based on the priority level of the each product that has been set. One example of the first information is remaining time to a sales time limit. One example of the second information is a continuously changing sales status of the each product. The promotional information is created to promote one or more products selected from the product group based on the priority level.

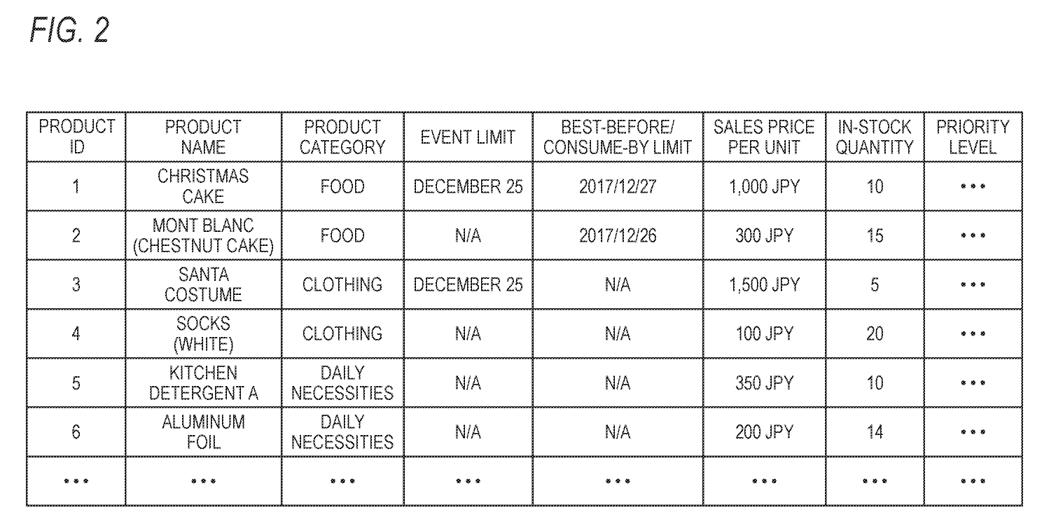

FIG. 2 is a diagram illustrating a product database. This example shows a product database of a store that sells items such as food, clothing, and daily necessities. The product database may contain data of a single store or data of multiple stores in a chain.

The product database includes data such as product ID, product name, product category, event limit, best-before/consume-by limit, sales price per unit, in-stock quantity, and priority level. The product ID is the identifier of a product. The product name is the name of the product. The product category indicates a category to which the product belongs.

The event limit is a time limit determined by an event that is related to the product. The event limit may not be set for all products. In this example, Christmas Cake and Santa Costume have the date of Christmas set as their event limits. For some products, such as tickets to an event that are sold in advance through a ticket booking service, the event limit may be earlier than when the actual event takes place. The best-before/consume-by limit is the best-before limit or the consume-by limit. The best-before/consume-by limit is not limited to best-before and consume-by limits; it may also be sell-by, display-until, and other similar limits. The best-before/consume-by limit may not be set for all products. In this example, the best-before/consume-by limit is set for food items. Daily necessities may also have their use-by limits set as their best-before/consume-by limits. The best-before/consume-by limit or the event limit, whichever is earlier, is set as the sales time limit. Remaining time to the sales time limit is one example of the first information.

The sales price per unit is the price per unit at which the product is sold to a consumer. The in-stock quantity is the quantity of the product that can be purchased from the store. The in-stock quantity is usually the number of sales units in stock. If the sales price goes by weight or volume, the in-stock quantity may be in weight or in volume. The in-stock quantity is one example of the second information. The priority level is set for the each product by using the first information and the second information. Details of the priority level will be provided later.

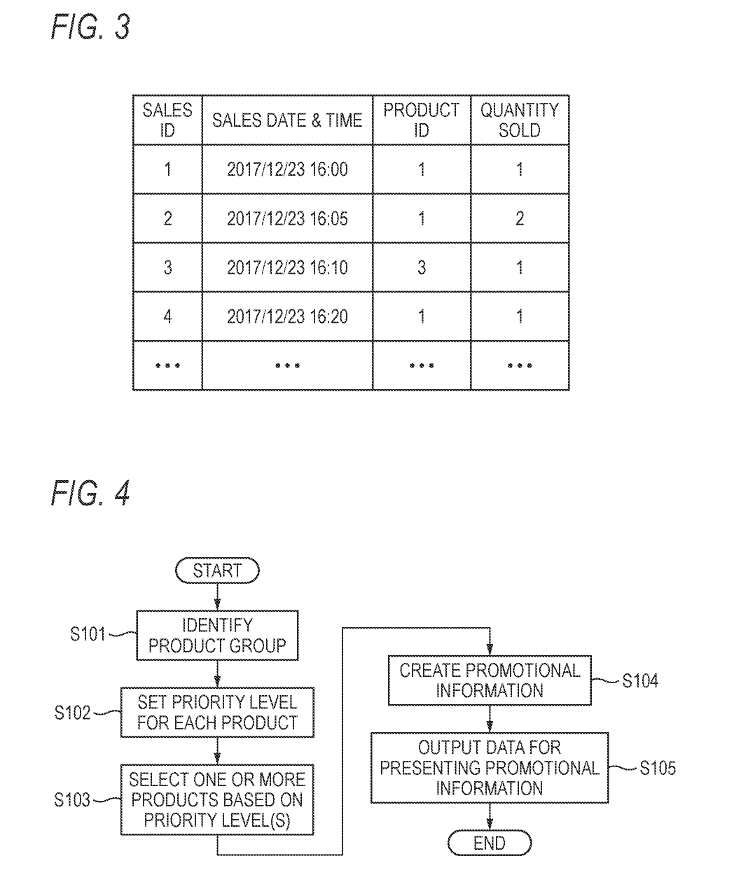

FIG. 3 is a diagram illustrating a sales history database. The sales history database contains data such as sales ID, sales date and time, and quantity sold. One example of the sales history database is a database storing data that is output from a point-of-sales (POS) system when products are sold. A record is added for each of the sold products when the payment is made at a POS register.

The sales ID is the identifier of a sales record. The sales date and time is the date and time at which the payment for the product was made. The product ID corresponds to the product ID in the product database. The quantity sold is the product quantity sold. The quantity sold usually indicates the number of sales units that sold. If the sales price goes by weight or volume, the quantity sold may be in weight or in volume. When a sales record is added to the sales history database, the product database is updated. Specifically, the quantity sold in the sales record is deducted from the in-stock quantity of the corresponding product in the product database.

FIG. 4 is a flowchart illustrating a data output procedure. In this example, the priority level is set by using the remaining time to the sales time limit, which is one example of the first information.

At step S101, the controller 11 identifies a product group. Specifically, when a user specifies a product category from the user input unit 15, the controller 11 extracts, from the product database, product IDs associated with the specified product category to identify a product group. For example, when the user specifies the food category, product ID=1 and product ID=2 are identified as in the product group. When the user specifies the clothing category, product ID=3 and product ID=4 are identified as in the product group. When the user specifies the daily necessities category, product ID=5 and product ID=6 are identified as in the product group.

At step S102, the controller 11 sets the priority level for each product. Specifically, the controller 11 sets the priority level for each product by using the first information. To do so, the controller 11 sets a sales time limit for each product. If the best-before/consume-by limit is set but the event limit is not set, the controller 11 sets the best-before/consume-by limit as the sales time limit. If the best-before/consume-by limit is not set but the event limit is set, the controller 11 sets the event limit as the sales time limit. If both are set, the controller 11 sets whichever is earlier as the sales time limit. For example, December 25 is set for product ID=1, December 26 for product ID=2, and December 25 for product ID=3.

The controller 11 sets the priority level by using remaining time to the sales time limit that has been set (example of the first information). For example, points may be given to each product in accordance with a predetermined rule based on the number of remaining days to the sales time limit from the date on which the data output procedure is executed to set the priority level. Specifically, the rule may be set to give one point if three or more days remain until the sales time limit, two points if two days remain, and three points if one day remains, wherein the more points are given, the higher the priority level is. If the data output procedure is executed on December 23, for example, two points are given for product ID=1 (sales time limit being December 25), one point for product ID=2 (sales time limit being December 26), and two points for product ID=3 (sales time limit being December 25).

At step S103, the controller 11 selects one or more products based on the priority level. Specifically, the controller 11 selects one or more products within a set limit (may be 1 or larger) according to the priority level(s) of the product(s)—from the highest to the lowest. If the maximum number of products that can be selected is 1, for example, product ID=1 is selected from the food category. The maximum number of products may be user-specified.

At step S104, the controller 11 creates promotional information. In one example, the storage 12 pre-stores photographical image data of each product and template data of a graphical design for an advertisement. For each of the product(s) selected at step S103, the controller 11 retrieves image data from the storage 12, and retrieves the product name and the sales price per unit from the product database. The controller 11 displays, on the display 14, an image created based on the image data, text data indicating the product name and the sales price per unit, and the template data. The controller 11 may accept, from the input unit 15, a user directive to edit the layout of the photo(s) on the template or the sales price(s) per unit. The controller 11 may also accept a user directive to add some text.

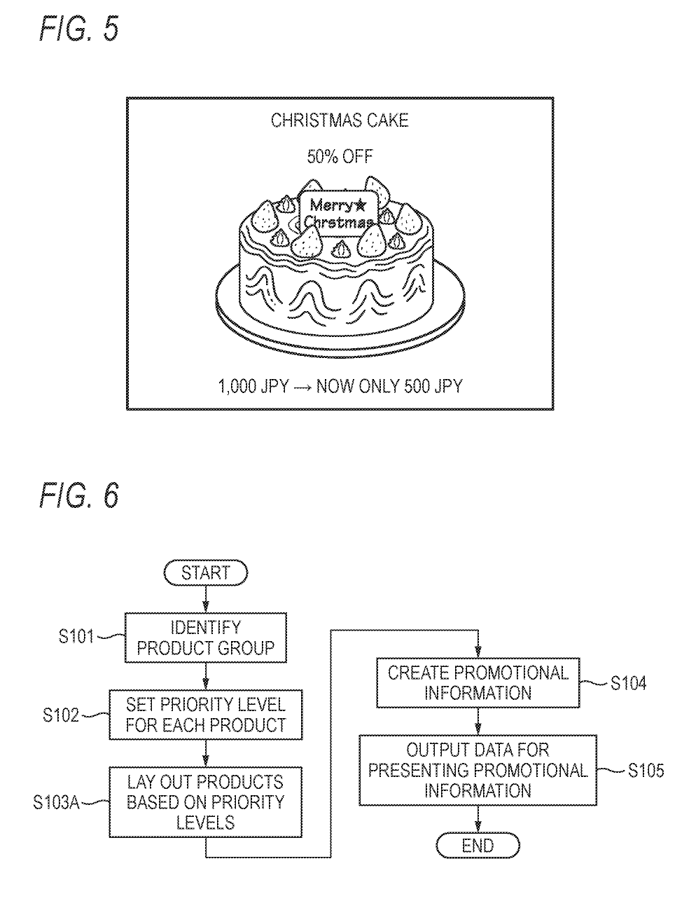

FIG. 5 is a diagram illustrating an example of promotional information. This is an example of promotional information that is created in response to product ID=1 (Christmas Cake) selected at step S103. The character string “Christmas Cake” in the diagram is the product name retrieved from the product database, and “1,000 JPY” is the sales price per unit retrieved from the product database. This example also has user-added character strings “50% OFF” and “Now Only 500 JPY”.

At step S105, the controller 11 outputs data for presenting the promotional information. Specifically, in response to a user directive to save the data in a specified data format, the controller 11 generates the data created at step S104 in the specified data format and stores the generated data on the storage 12. Examples of the data format include PDF (portable document format) and JPEG (Joint Photographic Experts Group), and the selection may vary depending on the media used to present the promotional information. Examples of the media used to present the promotional information include printed materials, display devices, advertisements linked to banners on Web pages, and promotion websites.

This embodiment enables (1) setting a priority level for each product in a product group by using a sales-time-limit-related first information and a sales-status-related second information of the each product, and (2) outputting data for presenting promotional information created based on the set priority level. The first information includes remaining time to a sales time limit and the second information includes a continuously changing sales status of the each product. In other words, the first information and the second information are information that indicates a status that changes over time.

The embodiment above may be modified, for example, as in the following modification examples. More than one modification examples may be combined.

### Modification Example 1

At step S102, the controller 11 may set the priority level for the each product by using the second information. The controller 11 retrieves, at a predetermined moment, the second information that covers a specific period of time from the product database or the sales history database. The predetermined moment may be predetermined time (9 am on December 24, for example), predetermined cycle (every 5 minutes, or every Monday, for example), the moment when the data output procedure is executed, and the like, and may be selected by the user. The specific period of time may be from the foundation date of the company to yesterday (yesterday being the end), yesterday's opening hours (yesterday's closing time being the end), one week to yesterday (yesterday being the end), last 24 hours (the moment at which the data output procedure is executed being the end), last week (Saturday being the end), the same month last year (the end of the same month last year being the end), and the like. The specific period of time may be selected by the user from given options, or directly specified by the user.

The second information includes at least one of in-stock quantity, purchased quantity, purchase price per unit, sales price per unit, or quantity sold over a period of time as information related to a sales status of each product that changes over time. For example, the controller 11 may set priority levels of the products in such manner that the larger the in-stock quantity is, the higher the priority level is set. A rule may be set to give one point for products with 5 or less in-stock quantity, two points for products with 6 to 10 in-stock quantity, and three points for products with 11 or more in-stock quantity, wherein the more points are given, the higher the priority level is. If this rule is applied to the products in the example product database in FIG. 3, the priority level will be 2 points for product ID=1 with its in-stock quantity being 10, 3 points for product ID=2 with its in-stock quantity being 15, and 1 point for product ID=3 with its in-stock quantity being 5.

Alternatively, the controller 11 may set the priority level for the each product in such manner that the larger the in-stock quantity multiplied by purchase price is, the higher the priority level is set. This is because the in-stock quantity multiplied by the purchase price indicates a loss that will occur if the in-stock quantity remains unsold.

Alternatively, the controller 11 may set the priority level for the each product in such manner that the larger the in-stock quantity divided by the purchased quantity is, the higher the priority level is set. This is because the in-stock quantity divided by the purchased quantity indicates the ratio of unsold quantity.

Alternatively, the controller 11 may set the priority level for the each product in such manner that the smaller the purchased price per unit divided by the sales price per unit, the higher the priority level is set. This is because the smaller the outcome of the calculation is, the more profitable the product is.

Alternatively, the controller 11 may set the priority level for the each product in such manner that the larger the quantity sold over a period of time is, the higher the priority level is set. This is based on an assumption that products that sold well over a period of time in the past could sell well if promoted. Examples of quantity sold over a period of time include quantity sold since the product went on sale, quantity sold yesterday, quantity sold over a week through yesterday, quantity sold over the most recent 24 hours, quantity sold last week, quantity sold in the same month last year, and the like.

### Modification Example 2

The present embodiment and the previous modification example work well for promotional information presented in a limited space. However, thanks to such capabilities as screen-switching and scrolling, a website of a virtual store has a virtually unlimited space for presenting promotional information. Therefore, it can be assumed that different placements have different degrees of promotional effectiveness, and the product layout should be determined taking this into account. In this modification example, the controller 11 outputs the data for presenting promotional information in such manner that products in a product group are laid out based on their priority levels.

FIG. 6 is a flowchart illustrating a data output procedure. Steps S101, S102, S104, and S105 are the same as those in FIG. 4. At step S103A, the controller 11 lays out the products based on their priority levels.

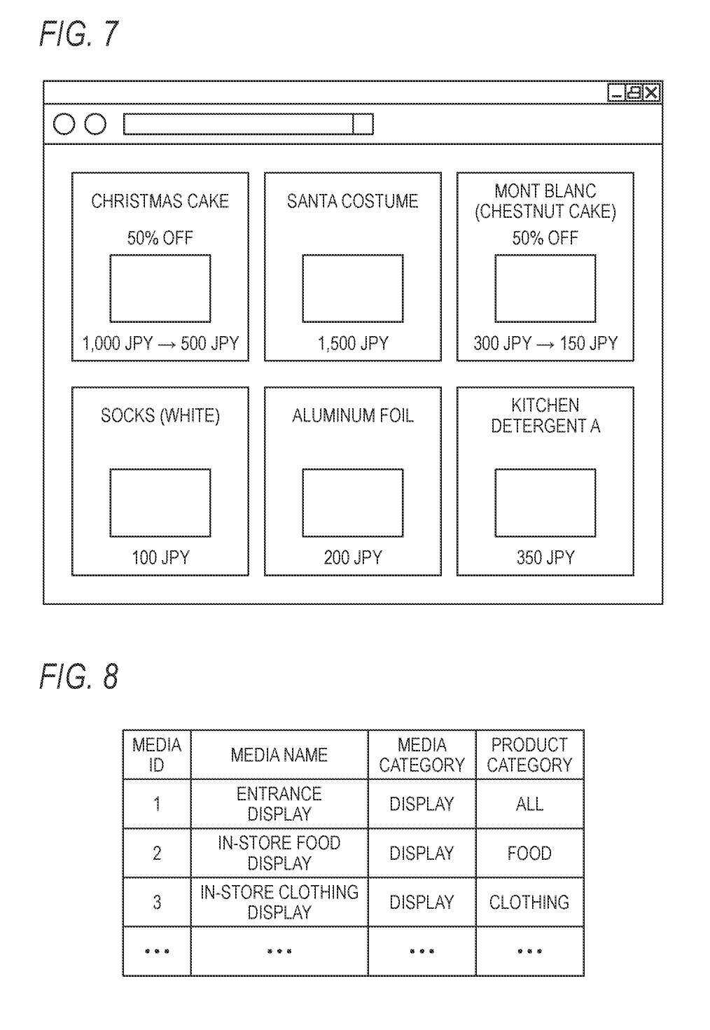

FIG. 7 is a diagram illustrating a product layout. This example product layout is created when the priority level is set for all items in the product database (see FIG. 2), wherein the priority level is set by multiplying a first priority level that is set by using the first information and a second priority level that is set by using the second information.

The first priority level is 2 points for product ID=1 with its sales time limit being December 25, 1 point for product ID=2 with its sales time limit being December 26, and 2 points for product ID=3 with its sales time limit being December 25. The second priority level is 2 points for product ID=1 with its in-stock quantity being 10, 3 points for product ID=2 with its in-stock quantity being 15, 1 point for product ID=3 with its in-stock quantity being 5.

The first priority level is multiplied by the second priority level for the each product to obtain the priority level for the each product. In this example, product ID=1 gets 2×2=4 points, product ID=2 gets 1×3=3 points, and product ID=3 gets 2×1=2 points. The priority levels for product IDs=4, 5, and 6 are set lower than the priority levels of product IDs=1, 2, and 3, and set solely based on their in-stock quantity. With the priority level of the each product set this way, the products will be laid out as illustrated in FIG. 7. The controller 11 may alternatively use the priority level that is set by using the first information or the priority level that is set by using the second information, whichever is higher or lower.

### Modification Example 3

The information processing apparatus 10 may receive a consumer attribute, and may identify the product group corresponding to the received consumer attribute based on a predetermined corresponding relationship. The consumer attribute is obtained, for example, by a video camera set up around the store entrance and an image processing apparatus that analyzes an image captured by the video camera. The video camera captures a person around the store entrance. The image processing apparatus performs face and body shape recognition on a person or persons in the captured image and analyzes attributes such as his/her age group and sex. The product database stores data such as potential target age group and/or sex of the each product, and the controller 11 identifies a product group that includes products that correspond to the obtained consumer attribute.

### Modification Example 4

The controller 11 of the information apparatus 10 may receive a directive from the user that specifies a media attribute, and may identify the product group corresponding to the specified media attribute based on a predetermined corresponding relationship.

FIG. 8 is a diagram illustrating a database of media used to present an advertisement. The media ID is the identifier of media used to present an advertisement. The media name is the name of the media. The media category indicates the category to which the media belongs. The product category indicates the product category to be shown on the media. In this example, media ID=1, Entrance Display, is a display located around the store entrance that displays products in all categories. Media ID=2, In-Store Food Display, is a display located at the food division of the store that displays food products exclusively. Media ID=3, In-Store Clothing Display, is a display located at the clothing division of the store that displays clothing products exclusively.

The display 14 displays a screen where the user can select a media name. In response to the user selecting a media name via the input unit 15, the controller 11 identifies the product group corresponding to the selected media.

### Modification Example 5

The program causing a computer to execute the process described above may be stored and provided in a non-transitory computer readable medium such as an optical recording medium and a semiconductor memory, or may also be distributed via a communication network such as the Internet. When the program pertaining to the present disclosure is stored in a non-transitory computer readable medium to be distributed, the computer reads the program from the recording medium to execute the program. When the program pertaining to the present disclosure is distributed via a communication network, the computer receives the program from a device of the distributor to execute the program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising a processor configured to:
set a priority level for each product in a product group by using first information and second information of the each product, the first information related to a sales time limit, the second information related to a sales status; and
output data for presenting promotional information created based on the priority level.

2. The information processing apparatus according to claim 1,
wherein the first information is remaining time to the sales time limit and the second information is information related to a sales status of the each product that changes over time.

3. The information processing apparatus according to claim 2,
wherein the sales status of the each product covers a specific period of time.

4. The information processing apparatus according to claim 3,
wherein the second information includes in-stock quantity,
wherein the larger the in-stock quantity is, the higher the priority level is set.

5. The information processing apparatus according to claim 3,
wherein the second information includes in-stock quantity and purchase price,
wherein the larger the in-stock quantity multiplied by purchase price is, the higher the priority level is set.

6. The information processing apparatus according to claim 3,
wherein the second information includes in-stock quantity and purchased quantity,
wherein the larger the in-stock quantity divided by the purchased quantity is, the higher the priority level is set.

7. The information processing apparatus according to claim 3,
wherein the second information includes quantity sold over a period of time in the past,
wherein the larger the quantity sold over a period of time in the past is, the higher the priority level is set.

8. The information processing apparatus according to claim 1,
wherein a best-before/consume-by limit or an event limit, whichever is earlier, is used as the sales time limit for the each product.

9. The information processing apparatus according to claim 1,
wherein the promotional information is created to promote one or more products selected from the product group based on the priority level.

10. The information processing apparatus according to claim 1,
wherein the layout of the one or more products presented in the promotional information is determined by the priority level(s) of the one or more products.

11. The information processing apparatus according to claim 1,
wherein the processor is further configured to:
receive a consumer attribute; and
identify the product group corresponding to the received consumer attribute based on a predetermined corresponding relationship.

12. The information processing apparatus according to claim 1,
wherein the processor is further configured to:
receive a directive from the user that specifies a media attribute; and
identify the product group corresponding to the specified media attribute based on a predetermined corresponding relationship.

13. A non-transitory computer readable medium storing a program causing a computer to execute a process, the process comprising:
setting a priority level for each product in a product group by using first information and second information of the each product, the first information related to a sales time limit, the second information related to a sales status; and
outputting data for presenting promotional information created based on the priority level.
